(19) United States
(12) Patent Application Publication
(10) Pub. No.: US 2007/0111077 A1
(43) Pub. Date: May 17, 2007

(54) Carbon dioxide remover for direct oxidation fuel cell and fuel cell system having the same

(76) Inventors: Eun-Suk Cho, Suwon-si (KR); Yasuki Yoshida, Suwon-si (KR); Ming-Zi Hong, Suwon-si (KR)

Correspondence Address: Robert E. Bushnell, Suite 300, 1522 K Street, N.W., Washington, DC, 20005-1202, US

(21) Appl. No.: 11/545,476

(22) Filed: Oct. 11, 2006

(30) Foreign Application Priority Data
Nov. 17, 2005 (KR) 10-2005-0110161

(51) Int. Cl. H01M 8/04; B01D 53/22

(52) U.S. Cl. 429/34; 96/4

(57) ABSTRACT

A carbon dioxide remover includes: a channel member which has the shape of a pipe which allows the non-reactive fuel and the carbon dioxide to flow, which is connected to the fuel cell body, and which includes a plurality of vent holes for discharging the carbon dioxide; a filter member which is disposed in the channel member to block the vent holes, which separates the carbon dioxide from the non-reactive fuel, and which passes only the carbon dioxide to the vent holes; and one or more suction members which have porosity to suck the non-reactive fuel, and which are disposed inside the channel member.

### CLAIM OF PRIORITY

This application makes reference to, incorporates the same herein, and claims all benefits accruing under 35 U.S.C. § 119 from an application for CARBON DIOXIDE REMOVER FOR DIRECT OXIDATION FUEL CELL AND FUEL CELL SYSTEM HAVING THE SAME, earlier filed in the Korean Intellectual Property Office on the 17 of Nov. 2005 and there duly assigned Serial No. 10-2005-0110161.

### BACKGROUND OF THE INVENTION

1. Technical Field

The present invention relates to a fuel cell system and, more particularly, to a fuel cell system employing a direct oxidation fuel cell scheme.

2. Related Art

A fuel cell is, as is well known, an electricity generating system for directly converting chemical reaction energy into electric energy through an electrochemical reaction between hydrogen contained in hydrocarbon materials and oxygen additionally supplied.

A fuel cell is mainly classified into a fuel cell with a reformer and used as a polymer electrolyte membrane fuel cell (PEMFC), and a direct oxidation membrane fuel cell without the reformer and used as a direct methanol fuel cell (DMFC).

The PEMFC includes a fuel cell body called a stack (hereinafter, referred to as a stack for the purpose of convenience). In the PEMFC, electric energy is generated through an electrochemical reaction between a hydrogen gas supplied from a reformer and air supplied by operating an air pump or a fan. The reformer functions as a fuel processing device which reforms a fuel, generates a hydrogen gas from the fuel, and supplies the hydrogen gas to the stack.

Unlike the PEMFC, in the direct oxidation fuel cell, an alcohol type fuel instead of hydrogen gas is directly provided, and electric energy is generated through an electrochemical reaction between hydrogen contained in the alcohol type fuel and oxygen additionally supplied.

In a fuel cell system employing a direct oxidation fuel cell scheme, the direct oxidation fuel cell discharges carbon dioxide, which is generated through a fuel oxidation reaction, and a non-reactive fuel remaining in the fuel cell. Thus, the fuel cell system needs to function as a recycling system which can remove the generated carbon dioxide and recycle the non-reactive fuel.

The recycling system includes a carbon dioxide remover which removes carbon dioxide while storing the non-reactive fuel and the carbon dioxide discharged from the fuel cell, and which recycles the non-reactive fuel as a fuel cell.

However, in this fuel cell system, a container is additionally required for storing the non-reactive fuel and the carbon dioxide discharged from the fuel cell. Thus, the overall structure of the fuel cell system is complicated due to the requirement for a container. Furthermore, the entire system is not compact because additional space is needed to install the container.

### SUMMARY OF THE INVENTION

The present invention provides a carbon dioxide remover for a direct oxidation fuel cell which has a simple structure and does not require additional space for installation, and a fuel cell system having the same.

According to an aspect of the present invention, the carbon dioxide remover for a direct oxidation fuel cell removes carbon dioxide discharged along with a non-reactive fuel from a fuel cell body which generates electric energy through a fuel reaction and an oxygen reaction, includes a carbon dioxide removing element which is disposed in a passage through which the non-reactive fuel and the carbon dioxide pass, and which discharges the carbon dioxide through the passage.

In addition, the carbon dioxide removing element may include a filter member which separates the carbon dioxide from the non-reactive fuel, and which passes only the carbon dioxide.

According to another aspect of the present invention, the carbon dioxide remover for a direct oxidation fuel cell removes carbon dioxide discharged along with a non-reactive fuel from a fuel cell body which generates electric energy through a fuel reaction and an oxygen reaction, wherein the carbon dioxide remover includes: a channel member which has the shape of a pipe which allows the non-reactive fuel and the carbon dioxide to flow, which is connected to the fuel cell body, and which includes a plurality of vent holes for discharging the carbon dioxide; a filter member which is disposed in the channel member to block the vent holes, which separates the carbon dioxide from the non-reactive fuel, and which passes only the carbon dioxide to the vent holes; and one or more suction members which have porosity so as to suck the non-reactive fuel, and which are disposed inside the channel member.

In the aforementioned aspect of the present invention, the filter member may be disposed on the outer circumferential surface of the channel member so as to block the vent holes.

The filter member may be disposed on the inner circumferential surface of the channel member so as to block the vent holes.

The filter member may have hydrophobicity, and may be buried in the vent holes so as to block the vent holes.

The filter member may have hydrophobicity, and may be provided in the form of a film. In this case, the filter member may be made of a fluorinated resin selected from the group consisting of PolyVinylidene-Fluoride, Fluoroethylene-Propylene, Polytetra-Fluoroethylene, FluorinatedEthylene-Propylene, PolyChloroTri-Fluoroethylene, and Fluoroethylene-Polymer.

The suction member may be made of a porous medium selected from among ceramic, foaming sponge, and metal foam.

The channel member may include a first region which is connected to the fuel cell body and which has vent holes, and a second region which excludes the first region. In this case, the suction member may block the channel passage, and may be disposed inside the second region.

According to another aspect of the present invention, a fuel cell system includes: a fuel cell body which generates electric energy through a fuel reaction and an oxygen reaction; a mix tank which stores a mixture fuel in which the fuel is mixed with water, and which supplies the mixture fuel to the fuel cell body; an oxygen supplier which supplies oxygen to the fuel cell body; and a carbon dioxide remover which is connected to the fuel cell body and the mix tank, which removes carbon dioxide discharged along with a non-reactive mixture fuel from the fuel cell body, and which supplies the non-reactive mixture fuel to the mix tank; wherein the carbon dioxide remover has the shape of a pipe forming a passage through which the non-reactive mixture fuel and the carbon dioxide pass, and includes a filter member which is disposed in the passage, which separates the carbon dioxide from the non-reactive mixture fuel, and which discharges the carbon dioxide out of the passage.

In the aforementioned aspect of the present invention, the carbon dioxide remover may include a channel member which includes: a plurality of vent holes for discharging the carbon dioxide, and which forms the passage; and a suction member which has porosity so as to suck the non-reactive fuel, and which is disposed inside the channel member.

The channel member may include a first region which is connected to the fuel cell body and has vent holes, and a second region which is connected to the mix tank and excludes the first region. In this case, the suction member may block the channel passage, and may be disposed inside the second region.

The filter member may be disposed on the channel member so as to block the vent holes. In this case, the filter member may have the shape of a film, and may be disposed on the outer circumferential surface of the channel member, may be disposed on the inner circumferential surface of the channel member, or may be buried in the vent holes so as to block the vent holes.

The suction member may be made of a porous medium selected from among ceramic, foaming sponge, and metal foam.

The oxygen supplier may include an air pump which sucks air and supplies the air to the fuel cell body. In this case, the non-reactive mixture fuel and the carbon dioxide may pass through the passage using pumping pressure of the air pump.

The mix tank may be connected to the fuel cell body, and may collect moisture discharged from the fuel cell body.

The fuel cell system may further include a fuel tank which is connected to the mix tank, which stores a pure fuel, and which supplies the pure fuel to the mix tank.

### BRIEF DESCRIPTION OF THE DRAWINGS

A more complete appreciation of the invention, and many of the attendant advantages thereof, will be readily apparent as the same becomes better understood by reference to the following detailed description when considered in conjunction with the accompanying drawings in which like reference symbols indicate the same or similar components, wherein:

FIG. 1 is a block diagram schematically showing the structure of a fuel cell system according to an embodiment of the present invention;

FIG. 2 is an exploded perspective view showing the structure of the fuel cell body of FIG. 1;

FIG. 3 is a partial perspective view schematically showing a carbon dioxide remover according to a first embodiment of the present invention;

FIG. 4 is a cross-sectional view of the carbon dioxide remover of FIG. 3;

FIG. 5 is a cross-sectional view of a carbon dioxide remover according to a second embodiment of the present invention; and

FIG. 6 is a cross-sectional view of a carbon dioxide remover according to a third embodiment of the present invention.

### DETAILED DESCRIPTION OF THE INVENTION

Hereinafter, exemplary embodiments of the present invention will be described in detail with reference to the attached drawings such that the present invention can be easily put into practice by those skilled in the art.

However, the present invention is not limited to the exemplary embodiments, but may be embodied in various forms.

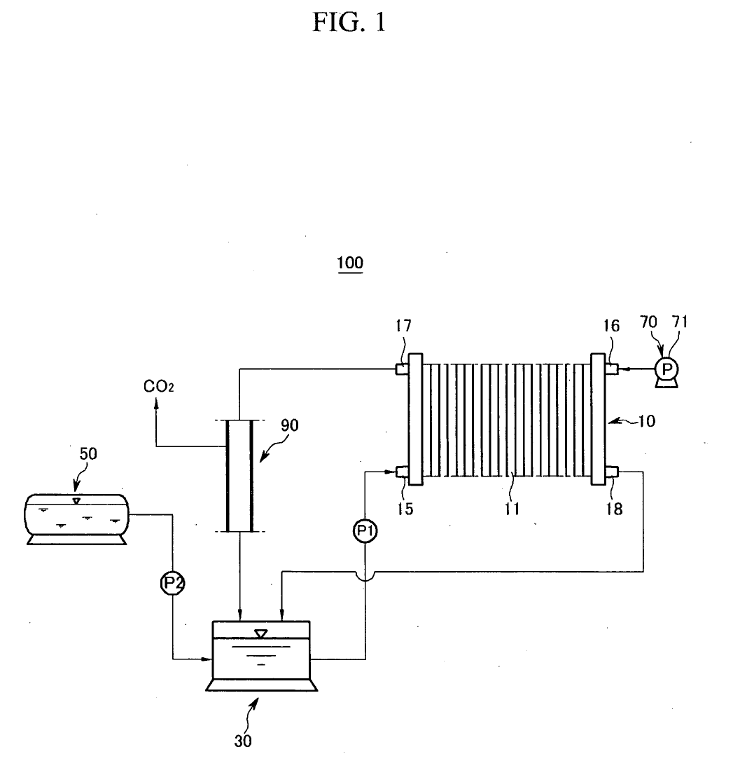

FIG. 1 is a block diagram schematically showing the structure of a fuel cell system according to an embodiment of the present invention.

Referring to FIG.1, a fuel cell system 100 according to an embodiment of the present invention may be formed using a direct oxidation fuel cell scheme such as a direct methanol fuel cell (DMFC), in which a fuel and an oxidant gas are directly provided, and electric energy is generated through an oxidation reaction of hydrogen contained in the fuel and through a reduction reaction of the oxidant gas.

The fuel cell system 100 functions as a recycling system in which carbon dioxide generated through a fuel oxidation reaction is removed when the direct oxidation fuel cell operates, and in which moisture generated through an oxygen reduction reaction and a non-reactive fuel remaining in the fuel cell after the reaction is completed can be recycled.

In the present embodiment, the fuel is a highly concentrated alcohol type liquid fuel such as methanol or ethanol. Hereinafter, a pure fuel combined with water is defined as a mixture fuel. The fuel cell system 100 may use oxygen stored in an additional storage element as an oxidant gas, or may use air containing oxygen. Hereinafter, the latter case will be exemplified.

The fuel cell system 100 includes a fuel cell body 10 formed as a direct oxidation fuel cell, a mix tank 30 for storing the mixture fuel, a fuel tank 50 for storing the pure fuel mentioned above, an oxygen supplier 70 for supplying oxygen to the fuel cell body 10, and a carbon dioxide remover 90 for removing carbon dioxide discharged along with a non-reactive mixture fuel from the fuel cell body 10.

The fuel cell body 10 is connected to the mix tank 30 and the oxygen supplier 70, respectively. Furthermore, the fuel cell system 100 includes an electricity generator 11 composed of cells to which the mixture fuel is supplied from the mix tank 30 and air is supplied from the oxygen supplier 70 so as to generate electric energy through an oxidation reaction of hydrogen contained in the fuel and through a reduction reaction of oxygen contained in the air.

The fuel cell body 10 may include a plurality of the electricity generators 11. The fuel cell body 10 may have a stack structure which is constructed by sequentially disposing the plurality of electricity generators 11.

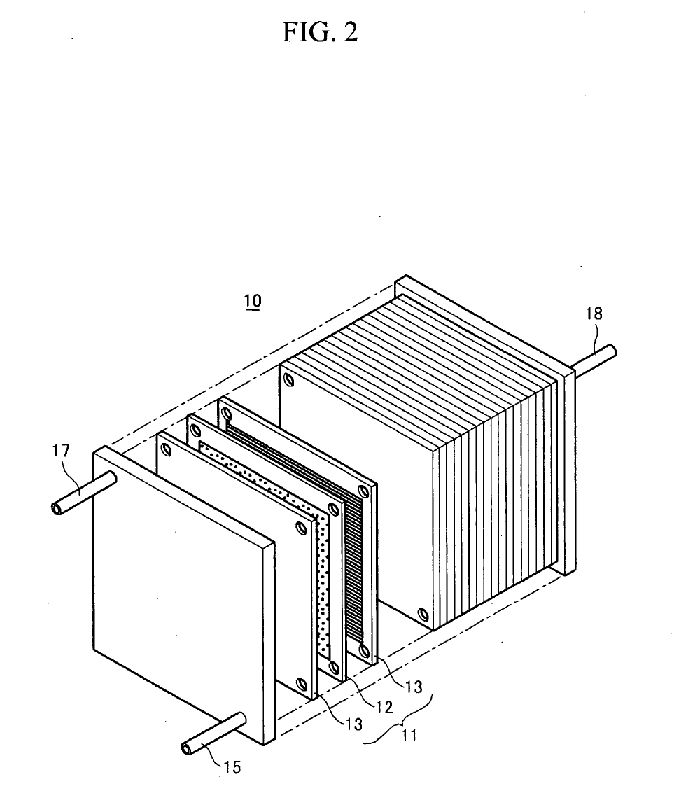

FIG. 2 is an exploded perspective view showing the structure of the fuel cell body 10 of FIG. 1.

Referring to FIG. 2, as described above, the fuel cell body 10 according to the present embodiment includes a plurality of the electricity generators 11. Each electricity generator 11 may include a membrane electrode assembly (MEA) 12 and separators 13, each disposed in close contact with both surfaces of an MEA 12.

The MEA 12 includes anode and cathode electrodes disposed on both sides thereof, and an electrolyte membrane interposed between the two electrodes.

The anode electrode decomposes hydrogen contained in a mixture fuel into electrons and hydrogen ions. The electrolyte membrane moves the hydrogen ions to the cathode electrode. The cathode electrode generates moisture by reacting the electrons and the hydrogen ions received from the anode electrode with oxygen supplied from the separators 13.

The separators 13 supply the mixture fuel to the anode electrode of the MEA 12, form a channel through which the mixture fuel and air are supplied to the cathode electrode of the MEA 12, and connect the anode and cathode electrodes of the MEA 12 in series.

Furthermore, the fuel cell body 10 includes a first injection hole 15 for supplying the mixture fuel to the electricity generators 11, a second injection hole 16 for supplying the air to the electricity generators 11, a first discharge hole 17 for discharging carbon dioxide generated through a fuel oxidation reaction performed by the electricity generators 11 and a mixture fuel remaining after the reaction is completed in the electricity generators 11, and a second discharge hole 18 for discharging moisture generated through an oxygen reduction reaction performed by the electricity generators 11 and air remaining in the electricity generators 11 after the reaction is completed.

As shown in FIG. 1, the mix tank 30 is a sealed tank having an internal space for storing the mixture fuel. In the mix tank 30, a highly concentrated pure fuel stored in the fuel tank 50 is mixed with water so as to supply the mixture fuel to the fuel cell body 10 after adjusting the concentration of the pure fuel to appropriate concentration required for operating the fuel cell body 10 effectively.

The mix tank 30 is connected to the first injection hole 15 of the fuel cell body 10 through a pipeline. Thus, the mixture fuel stored in the mix tank 30 is supplied to the electricity generators 11 of the fuel cell body 10. The mix tank 30 is connected to the fuel tank 50 through a pipeline, and selectively receives the pure fuel stored in the fuel tank 50. Also, the mix tank 30 is connected to the carbon dioxide remover 90, and receives a non-reactive mixture fuel after carbon dioxide is removed by the carbon dioxide remover 90. Furthermore, the mix tank 30 is connected to the second discharge hole 18 of the fuel cell body 10 through a pipeline, and receives moisture discharged from the second discharge hole 18 of the fuel cell body 10.

A first pump P1 is installed in the pipeline which connects the mix tank 30 to the first injection hole 15 of the fuel cell body 10. The first pump P1 sucks the mixture fuel stored in the mix tank 30, discharges the mixture fuel from the mix tank 30, and delivers the mixture fuel to the first injection hole 15 of the fuel cell body 10. A second pump P2 is installed in the pipeline which connects the mix tank 30 to the fuel tank 50. The second pump P2 sucks the pure fuel stored in the fuel tank 50, discharges the pure fuel from the fuel tank 50, and delivers the pure fuel to the mix tank 30.

A heat exchanger (not shown) may be installed in the pipeline which connects the mix tank 30 and the second discharge hole 18 of the fuel cell body 10. Such a heat exchanger condenses the moisture discharged from the second discharge hole 18 in the form of vapor.

as shown in FIG. 1, the oxygen supplier 70 for supplying oxygen to the fuel cell body 10 sucks air. In order to deliver the air to the fuel cell body 10, the oxygen supplier 70 includes an air pump 71. The air pump 71 and the second injection hole 16 of the fuel cell body 10 may be connected through a typical pipeline. The oxygen supplier 70 of the present embodiment is not limited to include the air pump 71, and may include a typical blower.

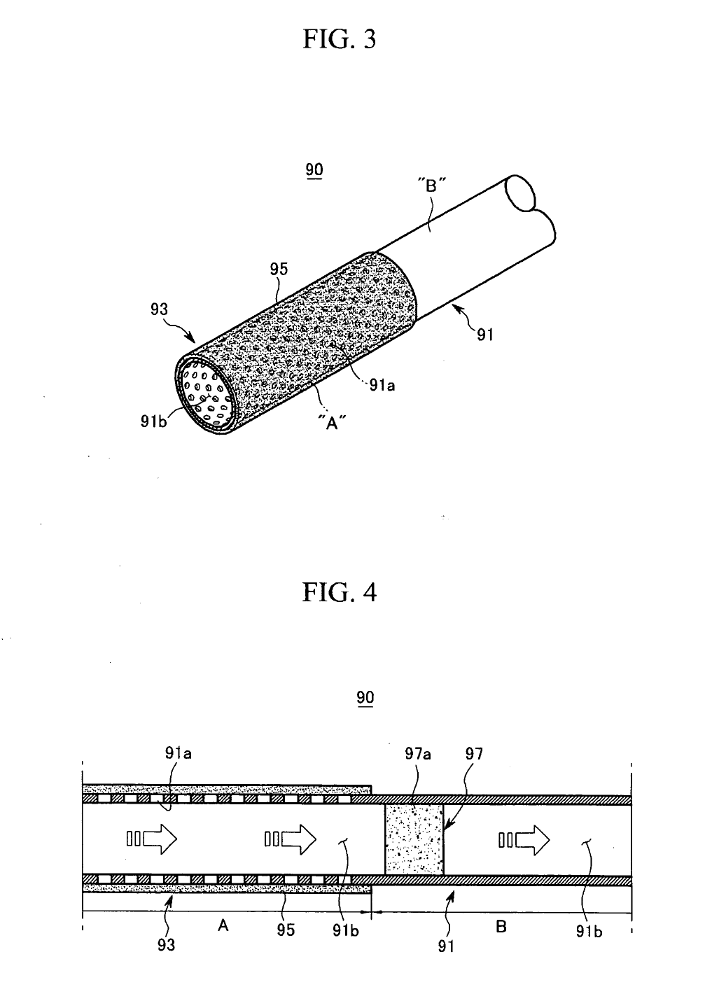

As shown in FIG. 1, the carbon dioxide remover 90 removes carbon dioxide while flowing the non-reactive mixture fuel discharged through the first discharge hole 17 of the fuel cell body 10 and the carbon dioxide, and supplies the non-reactive mixture fuel to the mix tank 30. The carbon dioxide remover 90 maybe disposed between the fuel cell body 10 and the mix tank 30, and may be connected to the first discharge hole 17 of the fuel cell body 10 and the mix tank 30. The carbon dioxide remover 90 according to an embodiment of the present invention will be described in detail with reference to FIGS. 3 and 4.

Since the fuel cell system 100 of the present embodiment includes the air pump 71 for supplying oxygen to the fuel cell body 10, the moisture generated through the oxygen reduction reaction performed by the electricity generators 11 and the air remaining in the electricity generators 11 after the reaction is completed can be discharged through the second discharge hole 18 of the fuel cell body 10 using pumping pressure of the air pump 71.

FIG. 3 is a partial perspective view schematically showing a carbon dioxide remover according to a first embodiment of the present invention, and FIG. 4 is a cross-sectional view of the carbon dioxide remover of FIG. 3.

Referring to FIGS. 3 and 4, the carbon dioxide remover 90 of the present embodiment includes a passage 91b for passing the non-reactive mixture fuel and the carbon dioxide discharged from the fuel cell body 10. The carbon dioxide remover 90 separates the non-reactive mixture fuel and the carbon dioxide passing through the passage 91b, so that the carbon dioxide is discharged out of the passage 91b and the non-reactive mixture fuel is supplied to the mix tank 30 (see FIG. 1) through the passage 91b.

includes a channel member 91 which forms the passage 91b and which is connected to the fuel cell body 10 and the mix tank 30, and a carbon dioxide removing element 93 which is formed on the channel member 91.

The channel member 91 is constructed in the shape of a pipe forming the passage 91b. The channel member 91 has a predetermined cross-sectional area through which the non-reactive mixture fuel and the carbon dioxide discharged from the fuel cell body 10 can pass. One end of the channel member 91 is connected to the first discharge hole 17 of the fuel cell body 10, and the other end of the channel member 91 is connected to an inflow portion (not shown) of the mix tank 30. The channel member 91 may be constructed in the shape of a pipeline having a rectangular or circular cross-section.

The carbon dioxide removing element 93 is formed on the passage 91b of the channel member 91. The carbon dioxide removing element 93 separates the non-reactive mixture fuel and the carbon dioxide passing through the passage 91b, and discharges the carbon dioxide out of the passage 91b.

The carbon dioxide removing element 93 includes a plurality of vent holes 91 a formed in the channel member 91 and a filter member 95 formed in the channel member 91 to block the vent holes 91a.

From between the non-reactive mixture fuel and the carbon dioxide passing through the passage 91b the vent holes 91a discharge the carbon dioxide out of the passage 91b.

The vent holes 91a may be formed over the entire area of the channel member 91. The vent holes 91a are formed in a first region A, and the first region A is defined as a portion connected to the first discharge hole 17 of the fuel cell body 10. On the other hand, a second region B is defined as a portion which is connected to the mix tank 30 and excludes the first region A of the channel member 91.

In order to block the vent holes 91a, the filter member 95 is attached to the outer circumferential surface of the channel member 91, that is, the outer circumferential surface of the first region A.

The filter member 95, which separates the non-reactive mixture fuel and the carbon dioxide passing through the channel member 91, functions as a vapor-liquid filter through which the non-reactive mixture passes and the carbon dioxide cannot pass. That is, the filter member 95 disposed on the outer circumferential surface of the channel member 91 blocks the vent holes 91a so as to prevent the non-reactive mixture fuel from discharging out of the passage 91b through the vent holes 91a. Thus, only carbon dioxide is discharged out of the passage 91b through the vent holes 91a.

The filter member 95 is provided in the form of a film having hydrophobicity which cannot pass the non-reactive mixture fuel and a porosity which can pass the carbon dioxide. The filter member 95 may be made of a fluorinated resin selected from the group consisting of PolyVinylidene-Fluoride, Fluoroethylene-Propylene, Polytetra-Fluoroethylene, FluorinatedEthylene-Propylene, PolyChloroTri-Fluoroethylene, or Fluoroethylene-Polymer.

Furthermore, the carbon dioxide remover 90 of the present embodiment includes a suction member 97 which has porosity and which is disposed inside the channel member 91. The suction member 97 sucks the non-reactive mixture fuel, and temporarily stores the non-reactive mixture fuel.

The suction member 97 has a plurality of air vents 97a for sucking the non-reactive mixture fuel. In order to block the passage 91b of the channel member 91, the suction member 97 is disposed inside the channel member 91. In the embodiment, the suction member 97 is disposed inside the second region B of the channel member 91.

The suction member 97 may be made of a typical porous medium such as ceramic, limestone, activated carbon, foaming sponge, or metal foam.

The suction member 97 sucks the non-reactive mixture fuel cell while blocking the passage 91b of the channel member 91. That is, the suction member 97 temporarily stores the non-reactive mixture fuel in the air vents 97a by sucking the non-reactive mixture fuel passing through the first region A of the channel member 91, and prevents the carbon dioxide from passing through the second region B due to the non-reactive mixture fuel stored in the air vents 97a.

As a result, since the carbon dioxide existing in the first region A of the channel member 91 is blocked by the suction member 97, the carbon dioxide cannot pass through the second region B. Instead, the carbon dioxide is guided toward the vent holes 91a, and is thus discharged through the filter member 95. The non-reactive mixture fuel sucked by the suction member 97 passes through the air vents 97a of the suction member 97 using the pumping pressure of the air pump 71 (see FIG. 1), and is supplied to the mix tank 30 (see FIG. 1) via the second region B.

The operation of the fuel cell system having the aforementioned structure according to an embodiment of the present invention will now be described in detail.

The mixture fuel stored in the mix tank 30 is supplied to the first injection hole 15 of the fuel cell body 10 by operating the first pump PI. The mixture fuel is then supplied to the electricity generators 11 through the first injection hole 15 of the fuel cell body 10. The pure fuel stored in the fuel tank 50 may be supplied to the mix tank 30 by operation the second pump P2 so as to adjust concentration of the mixture fuel stored in the mix tank 30.

In this process, the air pump 71 sucks air, and supplies the air to the second injection hole 16 of the fuel cell body 10. Thereafter, the air is supplied to the electricity generators 11 through the second injection hole 16 of the fuel cell body 10.

Accordingly, the fuel cell body 10 can output electric energy having a predetermined capacity through the fuel oxidation reaction and the oxygen reduction reaction performed by the electricity generators 11.

discharges carbon dioxide generated through the fuel oxidation reaction and a non-reactive mixture fuel remaining in the electricity generators 11 after the reaction is completed through the first discharge hole 17.

The non-reactive mixture fuel and the carbon dioxide discharged through the first discharge hole 17 of the fuel cell body 10 are supplied to the carbon dioxide remover 90 using the pumping pressure of the air pump 71, and then pass through the first region A of the channel member 91.

In this process, the non-reactive mixture fuel is sucked by the suction member 97 and is temporarily stored in the air vents 97a of the suction member 97, thereby preventing carbon dioxide from passing through the suction member 97. The carbon dioxide existing in the passage 91b of the first region A is blocked by the non-reactive mixture fuel sucked by the suction member 97, and thus cannot pass through the passage 91b of the second region B. Instead, the carbon dioxide is guided toward the vent holes 91a of the first region A, and is discharged to an additional collector or to the air through the filter member 95.

Meanwhile, the non-reactive mixture fuel sucked in the suction member 97 passes through the air vents 97a of the suction member 97 using the pumping pressure of the air pump 71, and is supplied to the mix tank 30 through the second region B.

In the process of generating electric energy, the fuel cell body 10 discharges moisture in the form of vapor, generated through the oxygen reduction reaction performed by the electricity generators 11 and air remaining in the electricity generators 11 after the reaction is completed, through the second discharge hole 18.

The moisture having a relatively high temperature and the non-reactive air discharged through the second discharge hole 18 of the fuel cell body 10 are processed by the heat exchanger (not shown). The moisture is condensed into water by the heat exchanger, and is collected in an internal space of the mix tank 30. The air is collected in the additional collector so as to be recycled to the fuel cell body 10 or discharged to the air.

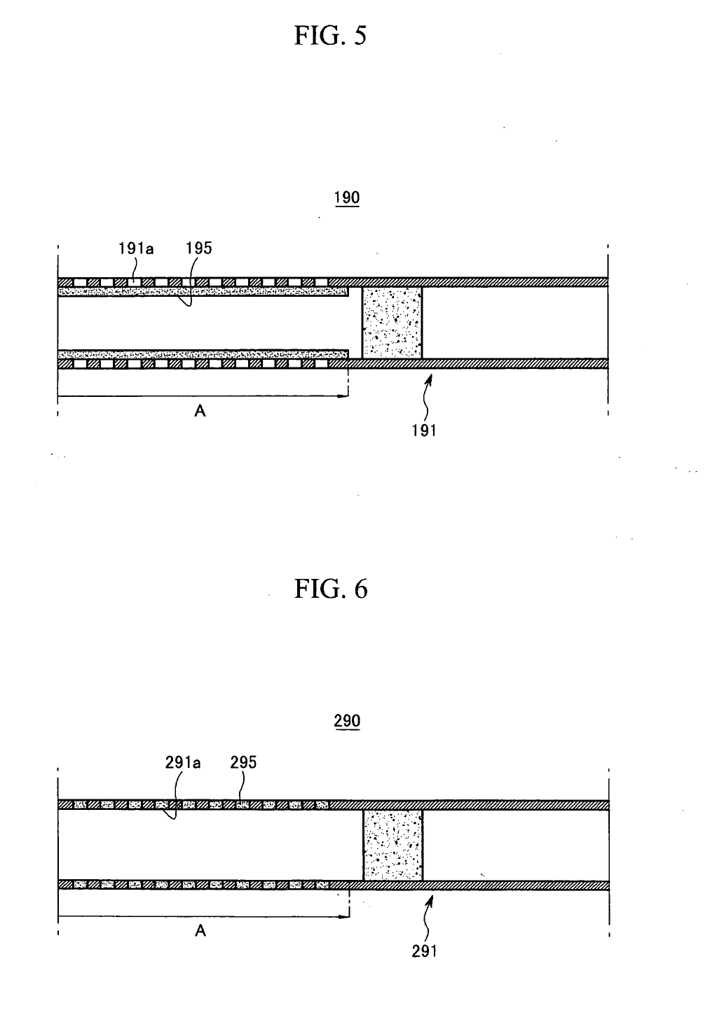

FIG. 5 is a cross-sectional view of a carbon dioxide remover according to a second embodiment of the present invention.

Referring to FIG. 5, the carbon dioxide remover 190 of the present embodiment basically employs the structure of the previous embodiment. The carbon dioxide remover 190 may include a filter member 195 which blocks a plurality of vent holes 191a of a channel member 191 and is disposed on internal walls of the channel member 191.

The filter member 195 is attached to the internal walls of the channel member 191, that is, internal walls of a first region A, and passes carbon dioxide existing inside the first region A through the vent holes 191a of the channel member 191.

The structure and operation of the carbon dioxide remover 190 of the present embodiment are the same as in the previous embodiment except as described above, and thus a detailed description thereof will be omitted.

FIG. 6 is a cross-sectional view of a carbon dioxide remover according to a third embodiment of the present invention.

Referring to FIG. 6, the carbon dioxide remover 290 of the present embodiment basically employs the structure of the previous embodiment. The carbon dioxide remover 290 may include a filter member 295 which is buried in a plurality of vent holes 291a of a channel member 291.

That is, the filter member 295 is inserted into the vent holes 291a of the channel member 291, and discharges carbon dioxide, existing inside first region A, through the vent holes 291a of the channel member 291.

The structure and operation of the carbon dioxide remover 290 of the present embodiment are the same as in the previous embodiment except as described above, and thus a detailed description thereof will be omitted.

According to the present invention, an additional container for storing a non-reactive mixture fuel and carbon dioxide discharged out of a fuel cell body is not required since a carbon dioxide remover having the shape of a pipe, such as a pipeline, is used. Therefore, the overall system structure is simplified.

According to the present invention, the entire system can be compact since additional space to install the system is not necessary.

Although exemplary embodiments of the present invention have been described, the present invention is not limited to the embodiments, but may be modified in various forms without departing from the scope of the appended claims, the detailed description, and the accompanying drawings of the present invention. Therefore, it is natural that such modifications belong to the scope of the present invention.

What is claimed is:

1. A carbon dioxide remover for a direct oxidation fuel cell, which removes carbon dioxide discharged along with a non-reactive fuel from a fuel cell body which generates electric energy through a fuel reaction and an oxygen reaction, the carbon dioxide remover comprising a carbon dioxide removing element which is disposed in a passage through which the non-reactive fuel and the carbon dioxide pass, and which discharges the carbon dioxide out of the passage.

2. The carbon dioxide remover of claim 1, wherein the carbon dioxide removing element comprises a filter member which separates the carbon dioxide from the non-reactive fuel, and which passes only the carbon dioxide.

3. A carbon dioxide remover for a direct oxidation fuel cell, which removes carbon dioxide discharged along with a non-reactive fuel from a fuel cell body which generates electric energy through a fuel reaction and an oxygen reaction, the carbon dioxide remover comprising:
a channel member which has a shape of a pipe which allows the non-reactive fuel and the carbon dioxide to flow, the channel member being connected to the fuel cell body and including a plurality of vent holes for discharging the carbon dioxide;
a filter member which is disposed in the channel member to block the vent holes, which separates the carbon dioxide from the non-reactive fuel, and which passes only the carbon dioxide to the vent holes; and
at least one suction member disposed inside the channel member and having a porosity for sucking the non-reactive fuel.

4. The carbon dioxide remover of claim 3, wherein the filter member is disposed on an outer circumferential surface of the channel member so as to block the vent holes.

5. The carbon dioxide remover of claim 3, wherein the filter member is disposed on an inner circumferential surface of the channel member so as to block the vent holes.

6. The carbon dioxide remover of claim 3, wherein the filter member has a hydrophobicity and is buried in the vent holes so as to block the vent holes.

7. The carbon dioxide remover of claim 3, wherein the filter member has a hydrophobicity and is provided in the form of a film.

8. The carbon dioxide remover of claim 3, wherein the filter member is made of a fluorinated resin.

9. The carbon dioxide remover of claim 8, wherein the fluorinated resin is selected from a group consisting of PolyVinylidene-Fluoride, Fluoroethylene-Propylene, Polytetra-Fluoroethylene, FluorinatedEthylene-Propylene, PolyChloroTri-Fluoroethylene, and Fluoroethylene-Polymer.

10. The carbon dioxide remover of claim 3, wherein said at least one suction member is made of a porous medium selected from a group consisting of ceramic, foaming sponge and metal foam.

11. The carbon dioxide remover of claim 3, wherein the channel member comprises a first region is connected to the fuel cell body and having the vent holes, and a second region which excludes the first region.

12. The carbon dioxide remover of claim 11, wherein the suction member blocks the channel passage, and is disposed inside the second region.

13. A fuel cell system, comprising:
a fuel cell body which generates electric energy through a fuel reaction and an oxygen reaction;
a mix tank which stores a mixture fuel in which fuel is mixed with water, and which supplies the mixture fuel to the fuel cell body;
an oxygen supplier which supplies oxygen to the fuel cell body; and
a carbon dioxide remover connected to the fuel cell body and the mix tank for removing carbon dioxide discharged along with a non-reactive mixture fuel from the fuel cell body, and for supplying the non-reactive mixture fuel to the mix tank;
wherein the carbon dioxide remover has a shape of a pipe forming a passage through which the non-reactive mixture fuel and the carbon dioxide pass, and includes a filter member disposed in the passage for separating the carbon dioxide from the non-reactive mixture fuel, and for discharging the carbon dioxide out of the passage.

14. The fuel cell system of claim 13, wherein the carbon dioxide remover comprises:
a channel member which includes a plurality of vent holes for discharging the carbon dioxide, and which forms the passage; and
a suction member disposed inside the channel member and having a porosity for sucking the non-reactive fuel.

15. The fuel cell system of claim 14, wherein the channel member comprises a first region connected to the fuel cell body and having the vent holes, and a second region which is connected to the mix tank and excludes the first region.

16. The fuel cell system of claim 15, wherein the suction member blocks the channel passage, and is disposed inside the second region.

17. The fuel cell system of claim 14, wherein the filter member is disposed on the channel member so as to block the vent holes.

18. The fuel cell system of claim 17, wherein the filter member has a shape of a film, and is disposed on an outer circumferential surface of the channel member.

19. The fuel cell system of claim 17, wherein the filter member has a shape of a film, and is disposed on an inner circumferential surface of the channel member.

20. The fuel cell system of claim 17, wherein the filter members are buried in the vent holes so as to block the vent holes.

21. The fuel cell system of claim 14, wherein the suction member is made of a porous medium selected from a group consisting of ceramic, foaming sponge and metal foam.

22. The fuel cell system of claim 13, wherein the oxygen supplier comprises an air pump which sucks air and supplies the air to the fuel cell body.

23. The fuel cell system of claim 22, wherein the non-reactive mixture fuel and the carbon dioxide pass through the passage using a pumping pressure of the air pump.

24. The fuel cell system of claim 13, wherein the mix tank is connected to the fuel cell body, and collects moisture discharged from the fuel cell body.

25. The fuel cell system of claim 13, further comprising a fuel tank connected to the mix tank for storing a pure fuel and for supplying the pure fuel to the mix tank.
